(19) United States
(12) Patent Application Publication
(10) Pub. No.: US 2006/0175952 A1
(43) Pub. Date: Aug. 10, 2006

(54) Field emission display device and method of manufacturing the same

(76) Inventors: Jeong-Hee Lee, Seongnam-si (KR); Mee-Ae Ryu, Suwon-si (KR); Sang-Hyun Lee, Yongin-si (KR); Jong-Hwan Park, Suwon-si (KR)

Correspondence Address: Robert E. Bushnell, Suite 300, 1522 K Street, N.W., Washington, DC, 20005-1202, US

(21) Appl. No.: 11/347,582

(22) Filed: Feb. 6, 2006

(30) Foreign Application Priority Data
Feb. 4, 2005 (KR) 10-2005-0010619

(51) Int. Cl. H01J 1/14; H01J 63/04

(52) U.S. Cl. 313/311; 313/497

(57) ABSTRACT

A field emission display (FED) device and a method of manufacturing the field emission display (FED) device are provided. The field emission display (FED) device has a structure in which a gate electrode and a cathode are formed on a substrate, and an adsorption prevention layer is formed on the gate electrode. The adsorption prevention layer, which is formed of an adsorption prevention material that reduces surface energy, prevents a gate electrode from absorbing carbon nanotube (CNT) residue by reducing the surface energy of the gate electrode.

This application makes reference to, incorporates the same herein, and claims all benefits accruing under 35 U.S.C. §119 from an application for FIELD EMISSION DISPLAY DEVICE AND MANUFACTURING METHOD THEREOF earlier filed in the Korean Intellectual Property Office on 4 Feb. 2005 and there duly assigned Serial No. 10-2005-0010619.

### BACKGROUND OF THE INVENTION

1. Field of the Invention

The present invention relates to a field emission display (FED) device and a method of manufacturing the same, and more particularly, to a field emission display (FED) device having a gate electrode in which an adsorption prevention layer is formed by surface treatment, and a method of manufacturing the field emission display (FED) device including surface treating of the gate electrode.

2. Description of the Related Art

A field emission display (FED) device is a display device that emits light from a fluorescent material layer formed on an anode by collision of electrons generated from a field emitter with the fluorescent material layer, where the field emitter is aligned with a gap on a cathode, by applying a strong electric field from a gate electrode.

Conventionally, a micro tip composed a metal such as Mo is used as a field emitter of a field emission display (FED) device, but research has recently found benefits in using carbon nanotubes (CNTs). The field emission display (FED) device that uses the carbon nanotube (CNT) emitter is very versatile, making it suitable for fields such as car navigators or view finders of electronic image devices, due to its advantages of wide viewing angle, high resolution, low power consumption, and high temperature stability. Especially, the field emission display (FED) device can be used as a display devices for personal computers, personal data assistants (PDA), medical equipment, and high definition televisions (HDTV). Also, the carbon nanotube (CNT) emitter can be used as a field emitter in a backlight of liquid crystal devices.

### SUMMARY OF THE INVENTION

The present invention provides a field emission display (FED) device in which carbon nanotube (CNT) residue is not absorbed on the surface of a gate electrode during a manufacturing process by reducing the surface energy of the gate electrode, and a method of manufacturing the field emission display (FED) device.

The present invention also provides a field emission display (FED) device comprising: a substrate; a cathode formed on the substrate; an insulating layer formed on the cathode and having a through hole corresponding to the cathode; a gate electrode formed on the insulating layer and having a gate hole corresponding to the through hole; a carbon nanotube (CNT) emitter formed on the cathode exposed on the bottom of the gate hole; and an adsorption prevention layer that prevents carbon nanotube (CNT) residue, formed on the surface of the gate electrode.

The adsorption prevention layer can not only be formed on the surface of the gate electrode, but also on the surface of the focusing gate electrode, when the focusing gate electrode is located on the gate electrode.

According to an aspect of the present invention, there is provided a method of manufacturing a field emission display (FED) device comprising: forming a cathode, an insulating layer having a through hole corresponding to a portion of the cathode, and a gate electrode having a gate hole corresponding to the through hole on a substrate; treating the surface of the gate electrode by coating an adsorption prevention material that reduces the surface energy of the gate electrode; and removing residue using a developing agent after coating a carbon nanotube (CNT) paste on the entire surface of the substrate and forming a carbon nanotube (CNT) emitter.

The surface treating of the gate electrode can be self-assembly coating the adsorption prevention material on the surface of the gate electrode by dipping the substrate on which the cathode, the insulating layer, and the gate electrode are formed in a solution in which the adsorption prevention material is dissolved.

The method can further comprise, after surface treating the gate electrode, forming a photoresist sacrificial layer on the upper surface of the gate electrode and on the inner surface of the gate hole, before coating the carbon nanotube (CNT) paste, and lifting off the photoresist sacrificial layer after removing the carbon nanotube (CNT) residue.

Regarding the principle of adsorption, the adsorption of carbon nanotube (CNT) residue by the gate electrode is related to the surface energies of the carbon nanotube (CNT) residue and the gate electrode. If the sum of the respective surface energies of the carbon nanotubes (CNTs) and the gate electrode with respect to a medium is greater than a surface energy when the carbon nanotubes (CNTs) are combined with the surface of the gate electrode, adsorption of the carbon nanotube (CNT) residue by the gate electrode occurs so that the surface can be stabilized.

Generally, the surface of a gate electrode formed of a metal is surrounded by an oxygen layer. Therefore, the adsorption prevention material may be a material that forms a single layer on the surface of the gate electrode through combining with the oxygen layer, and forms a surface having a lower surface energy than the oxygen layer on the outer surface of the single layer.

The adsorption prevention material can be experimentally selected through measurements of surface tension generated when coated on a metal surface. If a material meets the condition that the surface tension γ_{CS} of CNTs with respect to a coating layer formed of the material is greater than the sum the surface tension γ_{CL} of CNTs with respect to a developing agent and the surface tension γ_{SL} of the coating layer with respect to the developing agent, then the material ca be used as an adsorption prevention material since spontaneous adsorption between the coating layer and the carbon nanotubes (CNTs) does not occur in this condition.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIGS. 1A through 1E are cross-sectional views illustrating a method of forming carbon nanotubes (CNTs);

FIGS. 2A through 2E are cross-sectional views illustrating another method of forming carbon nanotubes (CNTs);

FIG. 3A a SEM (scanning electron microscope) image showing carbon nanotube (CNT) residue remaining on a gate electrode;

FIG. 3B is a photograph showing hot spots on a display image generated by the carbon nanotube (CNT) residue depicted in FIG. 3A;

FIG. 4 is a cross-sectional view illustrating a field emission display (FED) device having a gate electrode in which an adsorption prevention layer is formed according to a first embodiment of the present invention;

FIG. 5 is a cross-sectional view illustrating a field emission display (FED) device having a gate electrode in which an adsorption prevention layer is formed according to a second embodiment of the present invention;

FIGS. 6A and 6B are cross-sectional views illustrating a method of manufacturing a field emission display (FED) device according to the present invention;

FIG. 7 is a cross-sectional view illustrating an adsorption prevention layer formed in a focusing gate electrode according to the present invention; and

FIG. 8 is a graph showing the relationship between surface tension and adsorption force among particles, a medium and an objective surface.

### DETAILED DESCRIPTION OF THE INVENTION

The present invention will now be described more fully with reference to the accompanying drawings in which exemplary embodiments of the invention are shown.

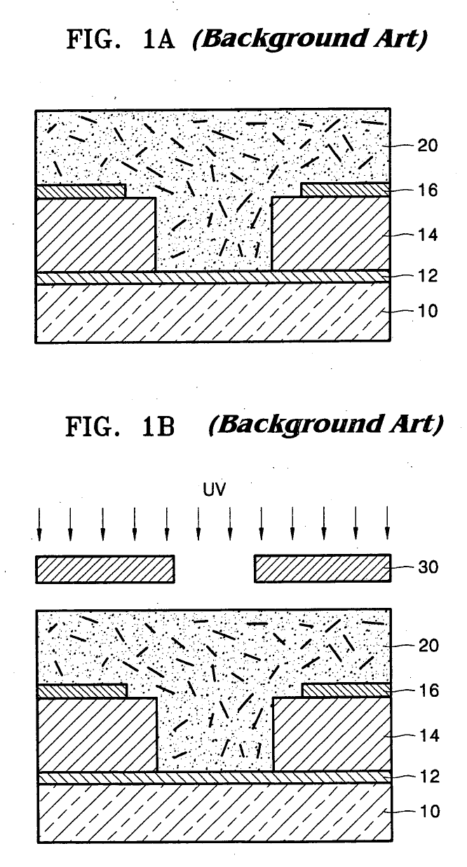

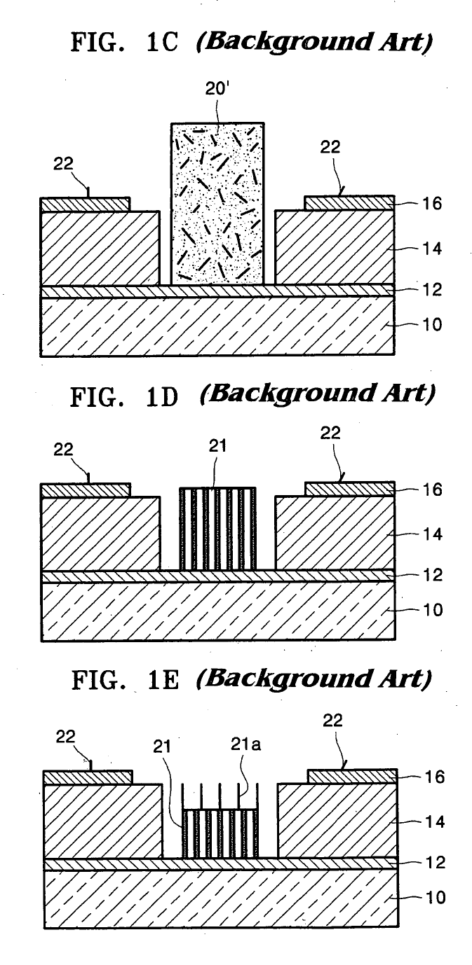

The carbon nanotube (CNT) emitter is generally formed from a carbon nanotube (CNT) paste by a photo process. FIGS. 1 A through 1E and FIGS. 2A through 2E are cross-sectional views illustrating a method of forming the carbon nanotube (CNT) emitter.

FIGS. 1A through 1E are cross-sectional views illustrating a method of forming a carbon nanotube (CNT) emitter applied to a field emission display (FED) device using a front-side exposure method.

Referring to FIG. 1A, a cathode 12, an insulating layer 14, and a gate electrode 16 are sequentially stacked on a substrate 10. A carbon nanotube (CNT) paste 20 is coated on the entire surface of the substrate 10 on which a gate hole that exposes a portion of the cathode 12 is formed, using a printing method. Next, as depicted in FIG. 1B, the carbon nanotube (CNT) paste 20 is selectively exposed by irradiating ultraviolet rays from the front-side of the substrate 10 using a mask 30. The exposed portion of the carbon nanotube (CNT) paste 20 is cured. Next, as depicted in FIG. 1C, only an exposed carbon nanotube (CNT) paste 20′ remains in the emitter hole, after the unexposed portion of the carbon nanotube (CNT) paste 20 is removed using a developing agent such as acetone. Next, as depicted in FIG. 1D, a carbon nanotube (CNT) emitter 21 is formed by shrinking the carbon nanotube (CNT) paste 20′ through a firing process. Finally, as depicted in FIG. 1E, pure carbon nanotubes (CNTs) 21 a are formed on the end of the carbon nanotube (CNT) emitter 21 when the surface of the carbon nanotube (CNT) emitter 21 is treated using an adhesive tape.

FIGS. 2A through 2E are cross-sectional views illustrating a method of forming a carbon nanotube (CNT) emitter applied to a field emission display (FED) device using a back-side exposure method.

Referring to FIG. 2A, a cathode 12, an insulating layer 14, and a gate electrode 16 are sequentially stacked on a substrate 10. After coating a sacrificial layer 40 composed of a photoresist on the entire surface of the substrate 10 on which a gate hole that exposes a portion of the cathode 12 is formed, a portion of the cathode 12 at the bottom of the gate hole is exposed by patterning. Next, as depicted in FIG. 2B, a carbon nanotube (CNT) paste 20 is coated on the entire surface of the resultant product of FIG. 2A using a printing method. Afterward, the carbon nanotube (CNT) paste 20 is selectively exposed by irradiating ultraviolet rays from the back-side of the substrate 10. At this time, the exposed portion of the carbon nanotube (CNT) paste 20 is cured. Next, as depicted in FIG. 2C, only an exposed carbon nanotube (CNT) paste 20′ remains in the emitter hole, after the unexposed portion of the carbon nanotube (CNT) paste 20 is removed using a developing agent such as acetone. Next, as depicted in FIG. 2D, a carbon nanotube (CNT) emitter 21 is formed by shrinking the carbon nanotube (CNT) paste 20′ through a firing process. Finally, as depicted in FIG. 2E, pure carbon nanotubes (CNTs) 21a are formed on the end of the carbon nanotube (CNT) emitter 21 when the surface of the carbon nanotube (CNT) emitter 21 is treated using an adhesive tape.

However, as depicted in FIGS. 1A through 1E and FIGS. 2A through 2E, it is often the case that carbon nanotube (CNT) residues 22 are absorbed by the surface of the gate electrode in the course of removing the remaining carbon nanotube (CNT) paste 20 after forming the carbon nanotube (CNT) emitter 21 using a developing agent.

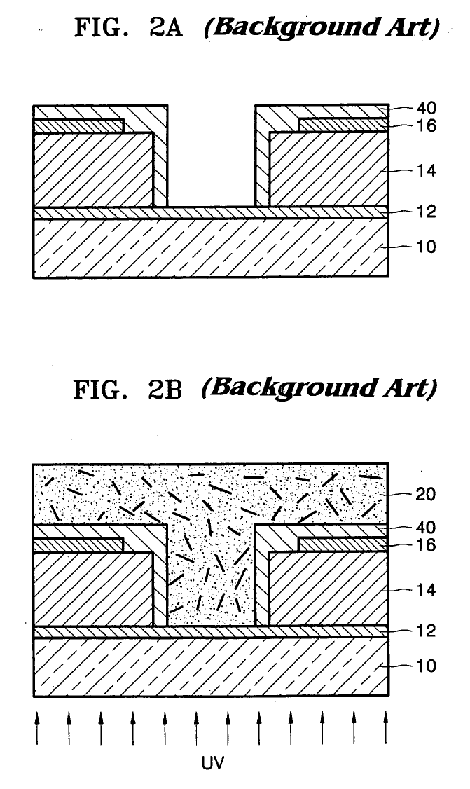

FIG. 3A is a SEM image showing carbon nanotube (CNT) residue absorbed by the surface of a gate electrode after forming a carbon nanotube (CNT) emitter using a carbon nanotube (CNT) paste. In this case, the carbon nanotube (CNT) residue 22 on the surface of the gate electrode 16 can be closer to an anode than the carbon nanotubes (CNTs) 21 on the carbon nanotube (CNT) emitter 21. Therefore, there is a possibility of emitting electrons through the carbon nanotube (CNT) residue 22.

In other words, there is high possibility of generating a diode emission that can not controlled by a signal between the gate electrode 16 and an anode due to the adsorption of the carbon nanotube (CNT) residues 22 on the gate electrode 16, and this can cause hot spots on a display image. FIG. 3B is a SEM image showing hot spots generated on a display image due to carbon nanotube (CNT) residue.

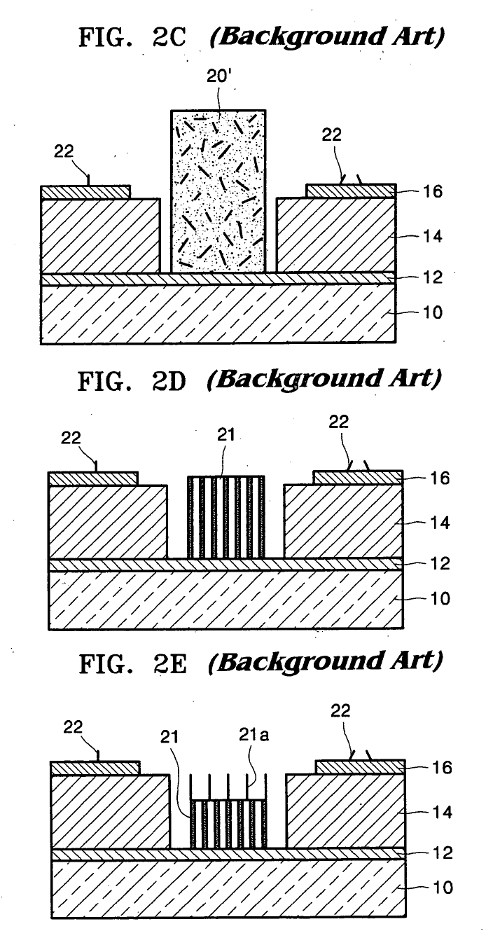

FIG. 4 is a cross-sectional view illustrating a field emission display (FED) device having a gate electrode in which an adsorption prevention layer is formed according to a first embodiment of the present invention. Referring to FIG. 4, a field emission display (FED) device according to the present invention comprises a substrate 10 on which a cathode 12 is formed, and a gate electrode 16 insulated from the cathode 12 by interposing an insulating layer 14 on the cathode 12. An adsorption prevention layer 100 formed of an adsorption prevention material according to an aspect of the present invention is formed on the surface of the gate electrode 16.

A carbon nanotube (CNT) emitter 21 is formed on the cathode 12 exposed on the bottom of the gate hole. carbon nanotube (CNT) residue may remain on the periphery of the carbon nanotube (CNT) emitter 21 in the course of a manufacturing process, but the adsorption prevention layer 100 prevents the carbon nanotube (CNT) residue from remaining on the surface of the gate electrode 16, since the adsorption prevention layer 100 formed of an adsorption prevention material having low surface energy surrounds the gate electrode 16.

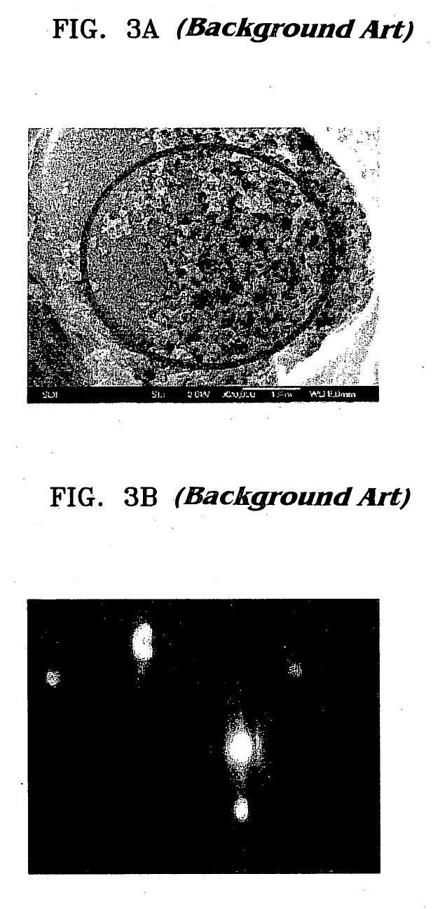

FIG. 5 is a cross-sectional view illustrating a field emission display (FED) device having a gate electrode in which an adsorption prevention layer is formed according to a second embodiment of the present invention. In the second embodiment, an insulating layer 15 on the gate electrode 16 which is described in the first embodiment and a focusing gate electrode 17 formed to surround the gate hole on the insulating layer 15 and collect electrons passed through a through hole and the gate hole are further included, and an adsorption prevention layer 100 is located on exposed surfaces of the gate electrode 16 and the focusing gate electrode 17.

The adsorption prevention layer 100 is formed to have a lower surface energy than the gate electrode 16. The low surface energy of the adsorption prevention layer 100 prevents carbon nanotube (CNT) residue or other minute particles from remaining on the surfaces of the gate electrode 16 or the focusing gate electrode 17 while forming the carbon nanotube (CNT) emitter 21.

Hereinafter, a method of manufacturing a field emission display (FED) device that includes a gate electrode having an adsorption prevention layer according to an embodiment of the present invention will now be described.

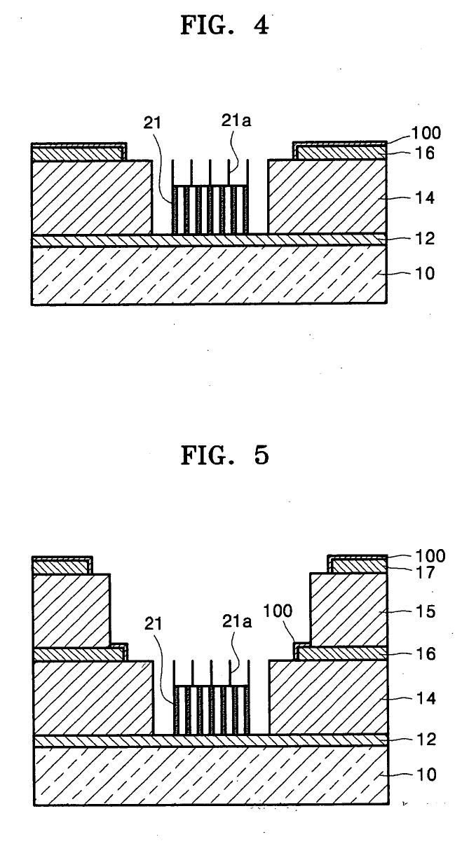

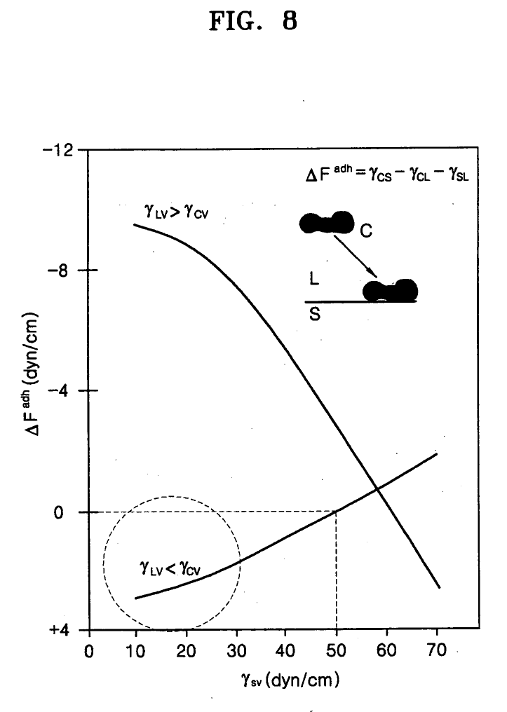

FIGS. 6A and 8B are cross-sectional views illustrating a method of manufacturing a field emission display (FED) device according to the present invention. In the present embodiment, a cathode 12 on the upper surface of a substrate 10, an insulating layer 14 having a through hole corresponding to the cathode 12, and a gate electrode 16 having a gate hole corresponding to the through hole, can be manufactured by well known processes in the conventional art.

In the present embodiment, the surface of the substrate 10 on which the cathode 12, the insulating layer 14, and the gate electrode 16 are formed is treated by immersion in a solution in which an adsorption prevention material is dissolved. At this time, the surface of the gate electrode 16 is formed of a metal such as chromium (Cr), and is surrounded by an oxygen layer, and the adsorption prevention material dissolved being hydrided in the solution. Therefore, a single layer of adsorption prevention layer 100 is coated on the surface of the gate electrode 16 through a reaction between the oxygen layer and the hydrided adsorption prevention material.

Referring to FIG. 6A, after forming the adsorption prevention layer 100 on the surface of the gate electrode 16, as depicted in FIG. 6B, a photoresist sacrificial layer 40 is formed on the upper surface of the adsorption prevention layer 100 and on the inner surfaces of the through hole and the gate hole. In this state, a carbon nanotube (CNT) paste 20 is coated on the entire front-side surface of the substrate using a printing method.

Next, when a carbon nanotube (CNT) emitter is formed by an exposure method, after curing the carbon nanotube (CNT) paste 20 by exposure to ultraviolet rays, the uncured portion of the carbon nanotube (CNT) paste 20 is removed using a developing agent such as acetone, and then the photoresist sacrificial layer 40 is lifted-off.

At this time, carbon nanotube (CNT) residue and foreign materials may contact the surface of the adsorption prevention layer 100 as it is mixed with the developing agent. However, the carbon nanotube (CNT) residue and foreign materials are washed away without being absorbed by the adsorption prevention layer 100, since the adsorption prevention layer 100 has a sufficiently low surface energy level not to combine with the carbon nanotube (CNT) residues.

In the present embodiment, the process for forming the photoresist sacrificial layer 40 and the lifting-off process for removing the photoresist sacrificial layer 40 when the remaining paste is removed using a developing agent, can be omitted. In this case, a carbon nanotube (CNT) emitter is preferably formed using a front-side exposure method.

However, in the method of manufacturing a field emission display (FED) device according to the present invention, the method of forming a cathode, an insulating layer, and a gate electrode, and the method of forming the carbon nanotube (CNT) emitter are not limited thereto, and can be replaced by various methods. Also, the formation of the adsorption prevention layer is not limited to self-assembly in a solution, but it can be formed by plasma surface treatment using a fluoride.

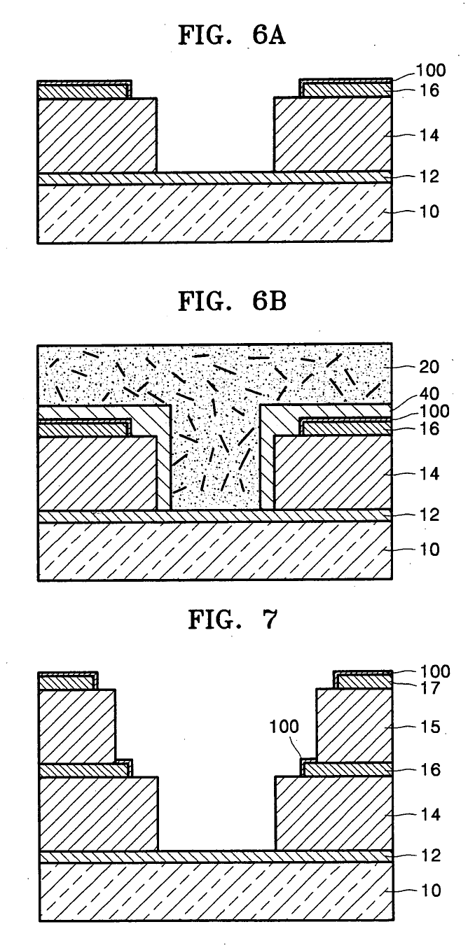

FIG. 7 is a cross-sectional view illustrating an adsorption prevention layer formed on a focusing gate electrode according to the present invention. An adsorption prevention layer 100 can be formed according to the method described above after forming another insulating layer 15 and a focusing gate electrode 17 on the gate electrode 16.

A method of selecting an adsorption prevention material for the above manufacturing method will now be described.

FIG. 8 is a graph showing the relationship between surface tension and adsorption force between particles, an objective surface, and a medium. The equation on the right upper of the graph indicates an adsorption force between an objective surface S and particles C. That is, the adsorption force ΔF^{adh} between an objective surface S and particles C is equal to the surface tension γ_{CS} of the particles C with respect to the objective surface S−[(the surface tension γ_{CL} of the particles C with respect to the medium L)+(the surface tension γ_{SL} of the objective surface S with respect to the medium L)]. When the adsorption force ΔF^{adh} is less than 0, spontaneous adsorption occurs between the particles C and the objective surface S. This fact has been disclosed in reference literature, such as Appl. Microbiol. Biotechnol 29_{—}346_{—}1988, Facchini and Colloids and Surfaces 42_{—}255_{—}1989, DiCosmo.

In FIG. 8, two lines are drawn. The line declining from the upper left toward the lower right of the graph shows the relationship between the surface tension GSV of the objective surface S with respect to a vacuum V and the adsorption force ΔF^{adh} between particles, C-objective surface S in the case when the surface tension γ_{LV} of the medium L with respect to the vacuum V is greater than the surface tension γ_{CV} of the particles, C with respect to the vacuum V, and the line inclining from the lower left toward the upper right of the graph shows the relationship therebetween in the case when γ_{LV} is less than γ_{CV}.

When these relationships are applied to the method of manufacturing a field emission display (FED) device according to the present invention, the developing agent, e.g. acetone, corresponds to the medium L, the carbon nanotube (CNT) residue corresponds to the particles C, and the surface of the gate electrode corresponds to the objective surface S.

The surface tension γ_{LV} of acetone is 22.9 dyn/cm and the surface tension γ_{CV} of the CNTs is approximately 40-50 dyn/cm. In this case, the second of the two lines in FIG. 8 is applied, since γ_{LV}<γ_{CV}. However, to prevent spontaneous adsorption, as is seen from the lines in FIG. 8, the γ_{SV} value must be less than 50 since, as described above, spontaneous adsorption occurs when the value of adsorption force ΔF^{adh} is less than 0.

In the case of Cr, which is conventionally used for forming a gate electrode, a surface reformation is necessary to maintain the surface tension less than 50, since the surface tension γ_{CS} of Cr is approximately 30-70 dyn/cm. The surface treatment of a gate electrode using an adsorption prevention material according to the present invention performs such surface reformation.

Accordingly, the adsorption prevention material must be selected from a material group that can be coated on the surface of a metal which meets the condition that the surface tension γ_{SV} <50 dyn/cm. From experiments, silane group organic compounds expressed as RSiX₃ have been shown to meet this condition, where Si is silicon, R represents an alkyl functional group or a group which is formed by substituting at least one hydrogen H of an alkyl group with fluoride F, and X represents a material having a group that hydrolyzes by H₂O.

Table 1 summarizes the surface tension GSV values of materials according to the kinds of residue heading a surface. These values have been disclosed in reference literature “Introduction to Ultrathin Organic Films” by A. Ulman, 1991.

TABLE 1

| Surface structure | GSV (dyn/cm, at 20° C.) |
|---|---|
| —CF₃ | 6 |
| —CF₂H | 15 |
| —CH₃ & —CF₂— | 17 |
| —CF₂ | 18 |
| —CH₂—CF₃ | 20 |
| —CH₃(crystal) | 22 |
| —CH₃(OTS monolayer) | 20 |
| —CH₃(C₂₂H₄₅SH monolayer on Au) | 19 |
| —CH₂ | 31 |
| —CClH—CH₂— | 39 |
| —CCl₂—CH₂— | 40 |
| ═CCl₂ | 43 |

When the experimental values disclosed in Table 1 and conditions of an adsorption prevention material to be coated on the surface of a gate electrode by forming a layer are considered, the adsorption prevention material can be a silane group organic compound in which a residue is an alkyl group, or a group which is formed by substituting at least one hydrogen H of an alkyl group with fluoride F. More specifically, the adsorption prevention material can be a silane group organic compound expressed as RSiX₃, where R is preferably a group selected from the group consisting of —CF₃, —CF₂H, —CF₃, —CF₂—, —CF₂, —CH₂—CF₃, and —CH₃, and X is preferably a group selected from the group consisting of —OH, —Cl, —OCH₂, —OCH₂—CH₃, and —H.

The adsorption prevention material can be any functional group that can be coated on the surface of a metal electrode and has a sufficiently low surface energy not to absorb carbon nanotube (CNT) residue or other foreign materials, and the adsorption prevention material according to the present invention is not limited the materials listed above.

According to the present invention, the adsorption of carbon nanotube (CNT) residue or other foreign materials by the surface of the gate electrode while manufacturing a carbon nanotube (CNT) emitter is prevented by reducing the surface energy of the gate electrode. Accordingly, the generation of diode emission between the gate electrode and an anode can be prevented, thereby preventing hot spots in a display image.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A field emission display device comprising:
a substrate;
a cathode formed on the substrate;
an insulating layer formed on the cathode and having a through hole exposing a portion of the cathode;
a gate electrode formed on the insulating layer and having a gate hole corresponding to the through hole;
a carbon nanotube emitter formed on the exposed cathode; and
an adsorption prevention layer formed on the surface of the gate electrode, said adsorption prevention layer preventing carbon nanotube residue from forming on the gate electrode.

2. The field emission display device of claim 1 further comprising a focusing gate electrode that collects electrons which pass through the through hole and the gate hole on the gate electrode,
wherein the adsorption prevention layer is formed on the surfaces of the gate electrode and the focusing gate electrode.

3. A method of manufacturing a field emission display device, comprising:
forming a cathode, an insulating layer having a through hole corresponding to a portion of the cathode, and a gate electrode having a gate hole corresponding to the through hole, on a substrate;
treating the surface of the gate electrode by coating an adsorption prevention material that reduces surface energy of the gate electrode; and
removing residue using a developing agent after coating a carbon nanotube paste on the entire surface of the substrate and forming a carbon nanotube emitter.

4. The method of claim 3, wherein the surface treatment of the gate electrode comprises self-assembly coating the adsorption prevention material on the surface of the gate electrode by dipping the substrate, on which the cathode, the insulating layer, and the gate electrode are formed, in a solution in which the adsorption prevention material is dissolved.

5. The method of claim 3, wherein the adsorption prevention material is a silane group organic compound in which a residue is an alkyl group or a group which is formed by substituting at least one hydrogen H of an alkyl group with fluoride F.

6. The method of claim 3, wherein the adsorption prevention material is a silane group organic compound expressed as RSiX₃, where Si is silicon, R represents an alkyl group or a group which is formed by substituting at least one hydrogen H of an alkyl group with fluoride F, and
X represents a material having a group that hydrolyzes by H₂O.

7. The method of claim 3, wherein the adsorption prevention material is a silane group organic compound expressed as RSiX_{3,} where Si is silicon, R is a group selected from the group consisting of —CF₃, —CF₂H, —CF₃, —CF₂—, —CF₂, —CH₂—CF₃, and —CH₃, and X is a group selected from the group consisting of —OH, —Cl, —OCH₂, —OCH₂—CH₃, and —H.

8. The method of claim 3 further comprising, after surface treating the gate electrode, forming a photoresist sacrificial layer on the upper surface of the gate electrode and on the inner surface of the gate hole, before coating the carbon nanotube paste, and lifting off the photoresist sacrificial layer after removing the carbon nanotube residue.

9. A method of manufacturing a field emission display device, comprising:
forming a cathode, an insulating layer having a through hole corresponding to a portion of the cathode, and a gate electrode having a gate hole corresponding to the through hole, on a substrate;
reducing the surface energy of the gate electrode by self-assembly coating an adsorption prevention material on the surface of the gate electrode by dipping the substrate, on which the cathode, the insulating layer, and the gate electrode are formed, in a solution in which the adsorption prevention material is dissolved; and
removing residue using a developing agent after coating a carbon nanotube paste on the entire surface of the substrate and forming a carbon nanotube emitter, wherein
the adsorption prevention material is a silane group organic compound expressed as RSiX₃, where Si is silicon, R represents an alkyl group or a group which is formed by substituting at least one hydrogen H of an alkyl group with fluoride F, and X represents a material having a group that hydrolyzes by H₂O.
